(19) United States
(12) Patent Application Publication
(10) Pub. No.: US 2010/0328053 A1
(43) Pub. Date: Dec. 30, 2010

(54) ARRAY-TYPE TACTILE FEEDBACK TOUCH PANEL

(75) Inventors: Yu-Chou YEH, Taoyuan County (TW); Min-Hui Chiang, Taoyuan County (TW)

Correspondence Address: RABIN & Berdo, PC, 1101 14TH STREET, NW, SUITE 500, WASHINGTON, DC, 20005, US

(73) Assignee: J TOUCH CORPORATION, Taoyuan County (TW)

(21) Appl. No.: 12/542,767

(22) Filed: Aug. 18, 2009

(30) Foreign Application Priority Data
Jun. 29, 2009 (TW) 098121839

(51) Int. Cl. G08B 6/00; G06F 3/041

(52) U.S. Cl. 340/407.2; 345/173

(57) ABSTRACT

An array-type tactile feedback touch panel includes a touch unit, a central processing unit (CPU), a vibration unit, and a display unit. The vibration unit has a plurality of thin vibrators. When the display unit displays a touch frame and a touch body performs a touch motion on the touch unit, the touch unit records a motion track during the touch motion and transmits the motion track to the CPU. Then, the vibration unit receives the motion track, and drives the vibrators under corresponding positions of the motion track to generate vibrations. Therefore, during the touch motion, a partial tactile feedback is generated at touch points of the touch body, and the tactile feedback effect is generated sequentially according to the motion track of the touch body.

### BACKGROUND OF THE INVENTION

1. Field of Invention

The present invention relates to a touch panel, and more particularly to an array-type tactile feedback touch panel capable of generating tactile feedback corresponding to a touch track.

2. Related Art

The improvements made on the existing touch technology are mainly classified into two types. In one type, a touch panel itself is enabled to sense changes of a medium, such as a resistive touch panel and a capacitive touch panel; in the other type, the improvement is made on operations, for example, evolving a touch panel from one touch to multi touch.

For users, it is much more important to make the touch operation become user-friendly and to enable the users to have a real feeling during the touch operation, which is so-called a feedback.

Therefore, most touch panels generate corresponding sounds when being touched by a touch body, such as a finger or a touch pen, and give a feedback about the touch motion to the user through the sounds.

Another common feedback technology is using vibrations. Most electronic products such as mobile phones and personal digital assistants (PDAs) are disposed with micro-motors, and when a touch body touches a touch panel, a certain micro-motor generates vibrations, and thus the manner of producing vibration feedback during the touch motion is referred to as a tactile feedback or touch feedback.

The tactile feedback effect can be achieved through the micro-motors, but, after all, the micro-motors have structures of conventional motors, and thus have main defects of high power consumption, large starting current, easily producing heat after working for a long time, and the volumes thereof can only be reduced to a limited extent.

Along with the development of piezoelectric materials, actuators made of piezoelectric materials such as piezoelectric actuators or piezoelectric motors have been better miniaturized in terms of both volume and thickness. The piezoelectric effect mainly includes two types, namely, a direct piezoelectric effect and a converse piezoelectric effect. Once a pressure is applied to a piezoelectric body, an electric dipole moment in the body is reduced along with the compression of the material, and at this time, in order to counteract such a compression trend, a voltage is generated in the piezoelectric body to keep the original state, which is the so-called direct piezoelectric effect. On the contrary, once an electric field is applied to the piezoelectric body, the electric dipole moment is elongated, and the piezoelectric body extends along a direction of the electric field to convert electrical energy into mechanical energy, which is the so-called converse piezoelectric effect. The above-mentioned piezoelectric actuators and piezoelectric motors are capable of generating the mechanical energy such as vibrations according to the converse piezoelectric effect.

The piezoelectric actuators are generally classified into two types in applications.

The first type of piezoelectric actuator is a piezoelectric actuator utilizing simple linear displacement generated by a longitudinal effect and a lateral effect of piezoelectric elements, and the motions thereof may be considered as that of a linear motor having micro/nano-scale micro power. The first type of piezoelectric actuator includes a single layer element, a laminated element, a tubular element, and the like.

The second type of piezoelectric actuator is a piezoelectric actuator utilizing composite bending displacement capable of generating a large displacement, which is generally made of piezoelectric elements or other elastic materials. The second type of piezoelectric actuator includes a unimorph, a bimorph, and the like.

The single-layer piezoelectric element has a simple structure but a very small displacement. A common single-layer piezoelectric element has a thickness of about 0.1-1 mm, and generates a displacement of about 100 nm. In recent years, with the rapid progress of fine machining technology of the micro-electro-mechanical system (MEMS), the piezoelectric materials may be formed into thin films with a response frequency between 100 MHz and several GHz. As for a driving manner of the single-layer piezoelectric element, a voltage is applied in a thickness direction of the piezoelectric element, and the polarization occurs in the material, so as to generate extended and compressed deformations. The polarization process is similar to a process of accumulating charges on a capacitor, so that the piezoelectric element also has properties of a capacitor.

The laminated piezoelectric element is generally formed by laminating tens of to hundreds of single-layer piezoelectric elements together, among which a thin film is sandwiched between each two layers for isolation, and thus a displacement much larger than that of the single-layer piezoelectric element is obtained. The displacement thereof is between several microns and tens of microns, and an inherent frequency thereof is about between several KHz and several tens of KHz. The laminated piezoelectric element also has higher energy conversion efficiency than the single-layer piezoelectric element. Each two single-layer piezoelectric elements are spaced apart by an electrode, and a polarization direction of each single-layer piezoelectric element is made to be opposite to the polarization directions of adjacent single-layer piezoelectric elements. Therefore, the laminated piezoelectric element is of series connection in the mechanical structure, but of parallel connection in the electrical characteristics. The laminated piezoelectric element is driven by applying a voltage simultaneously to all the single-layer piezoelectric elements to make them generate displacements in their respective polarization directions.

In U.S. Pat. No. 7,336,260, entitled “Method and Apparatus for Providing Tactile Sensations”, a tactile feedback technology is provided, in which a piezo ceramic element is disposed under a mechanical input apparatus (for example, a mechanical switch) and a non-mechanical input apparatus (for example, a touch panel), and thus, when a touch body performs a touch motion, the piezo ceramic element generates vibrations.

In US Patent No. 20070024593, entitled “Touch Device and Method for Providing Tactile Feedback”, an electro acoustic transducer is disposed under a touch panel, and when a touch body touches a specific area of the touch panel, the electro acoustic transducer generates vibrations.

In US Patent No. 20070080951, entitled “Input Device and Electronic Device Using the Input Device”, a plurality of piezoelectric actuators is disposed between a touch panel and a liquid crystal display panel and arranged at four side edges, and when a touch motion is performed, any of the piezoelectric actuators may be used to generate vibrations.

In US Patent No. 20080122315, entitled “Substrate Supporting Vibration Structure, Input Device Having Haptic Function, and Electronic Device”, a plurality of vibration applying portions is disposed between a touch panel and a liquid crystal display panel and mainly located at two opposite side edges, and when a touch motion is performed, any of the vibration applying portions may be used to generate vibrations.

Although the above patents realize the tactile feedback during the touch motion, it is known from the patents that, once the touch motion is performed, all vibration devices for generating vibrations (for example, the piezo ceramic element disclosed in U.S. Pat. No. 7,336,260, the electro acoustic transducer disclosed in US Patent No. 20070024593, and the piezoelectric actuators disclosed in Patent No. 20070080951) take the whole touch panel as a vibration sensing area during the vibrating process. In other words, currently, the touch operation has developed from one touch to multi touch, but the above patents fail to realize an independent tactile feedback for a single touch point (or called a contact point or a position on the touch panel touched by the touch body). Therefore, when the tactile feedback is realized, the whole touch panel generates vibrations with the same vibration source, regardless of the number of touch points, which cannot effectively improve the real feeling of the tactile feedback.

Furthermore, in the above patents, in order to prevent the opaque vibration devices from shielding the liquid crystal display panel, the vibration devices have to be disposed at peripheral edges of the touch panel and the liquid crystal display panel, or disposed at the bottom of the liquid crystal display panel. Thus, the vibrations generated by the vibration devices firstly pass through the touch panel and the liquid crystal display panel, and then received by the touch body such as the finger and touch pen, so that the vibration effect is greatly deteriorated, thereby resulting in a reduced sensing force of the tactile feedback.

### SUMMARY OF THE INVENTION

The present invention is directed to an array-type tactile feedback touch panel, which is capable of generating a partial tactile feedback at positions touched by a touch body.

The present invention is directed to an array-type tactile feedback touch panel, which is capable of generating tactile feedback sequentially according to a motion track of a touch body.

The present invention is directed to an array-type tactile feedback touch panel, which is capable of enhancing a vibration effect of a tactile feedback.

The present invention is directed to an array-type tactile feedback touch panel having transparent vibration elements.

In order to achieve the above objectives, the present invention provides an array-type tactile feedback touch panel, which includes a touch unit, a central processing unit (CPU), a vibration unit, and a display unit.

The touch unit includes: a touch panel, provided for a preset touch body to perform a touch operation, and a touch driver unit, electrically connected to the touch panel. The touch driver unit is used to compute a motion track of the touch body.

The CPU is used to receive the motion track, and is electrically connected to the display unit and the touch unit respectively.

The vibration unit includes a plurality of thin vibrators and a vibration driver unit for driving the vibrators to operate to generate vibrations.

The display unit is used to display a preset touch frame.

The touch panel is stacked on a top surface of the display unit, and the vibrators of the vibration unit are disposed on a top surface of the touch panel, disposed on a bottom surface of the display unit, or disposed between the touch panel and the display unit.

Therefore, when the touch body performs a touch motion on the touch panel of the touch unit, the touch driver unit records the motion track of the touch body, and transmits the motion track to the CPU. Meanwhile, the CPU computes the vibrators of the vibration unit corresponding to the motion track during the touch motion of the touch body, and the vibration unit drives the vibrators to generate vibrations after being touched by the touch body.

In other words, since the vibration unit is disposed at the touch unit, when the touch body touches the touch panel, the vibrators corresponding to positions of touch points generate vibrations, whereas the vibrators in the other positions do not generate vibrations. Meanwhile, when the touch body moves on the touch panel, the vibrators generate vibrations along with the displacement of the touch body, so as to form the tactile feedback (or called touch feedback), and stop vibrating when the touch body moves away.

In addition, in practical applications, the so-called touch body in the present invention may be a finger of a human, a touch pen exclusively used for performing touch motions, or an object commonly used in the touch motions, which all fall within the scope of the touch body in the present invention. Furthermore, the so-called motion track in the present invention is not limited to the motion track under the mode of one touch or multi touch.

### BRIEF DESCRIPTION OF THE DRAWINGS

FIG. 1 is a first block diagram of a preferred embodiment of the present invention;

FIG. 2 is a second block diagram of a preferred embodiment of the present invention;

FIG. 3 is a three-dimensional view of a preferred embodiment of the present invention;

FIG. 4 is a three-dimensional exploded view of a preferred embodiment of the present invention;

FIG. 5 is a partially exploded view of a preferred embodiment of the present invention;

FIG. 6 is a flow chart of a preferred embodiment of the present invention;

FIG. 7 is a schematic view of motions of a preferred embodiment of the present invention;

FIG. 8 is a three-dimensional view of another preferred embodiment of the present invention; and

FIG. 9 is a three-dimensional view of still another preferred embodiment of the present invention.

### DETAILED DESCRIPTION OF THE INVENTION

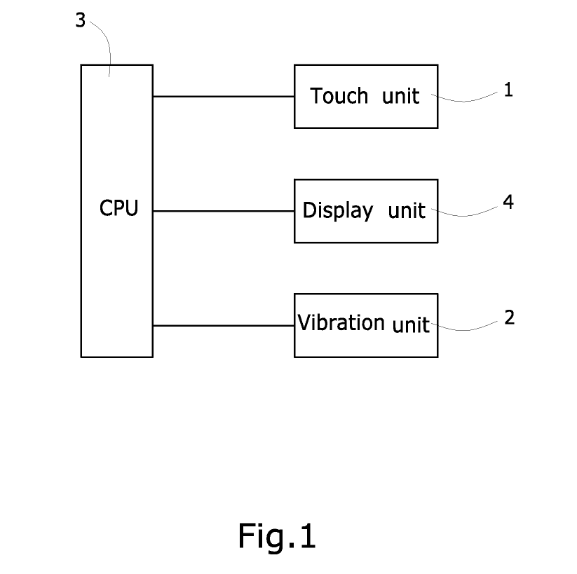

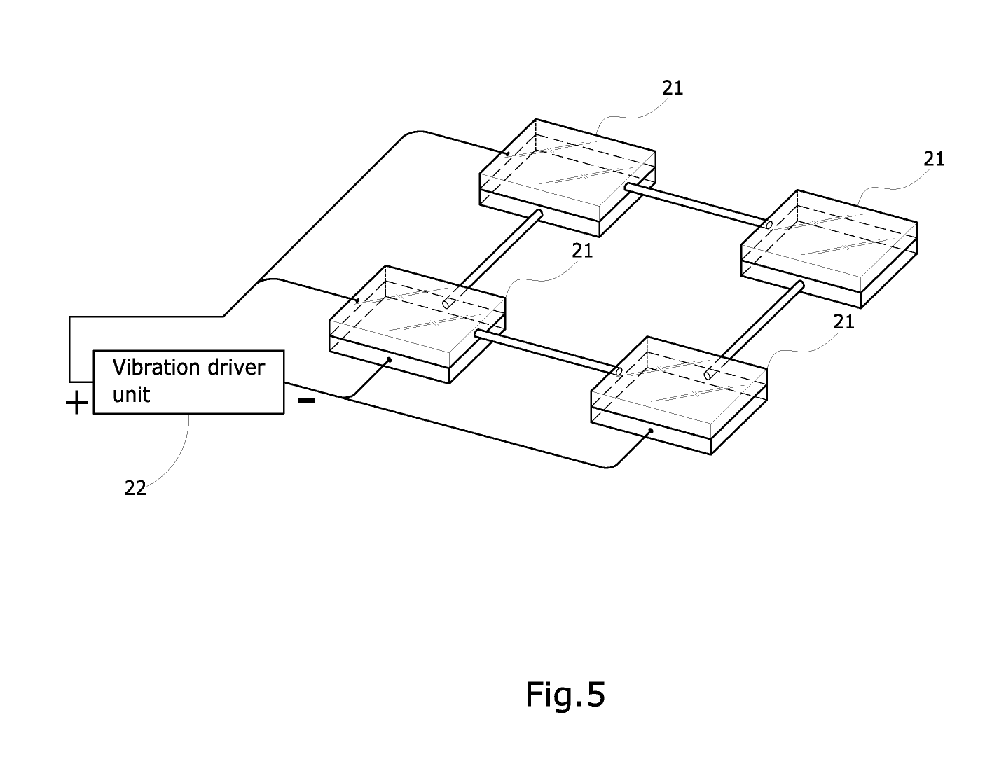

Referring to FIGS. 1-5, a first block diagram, a second block diagram, a three-dimensional view, a three-dimensional exploded view, and a partially exploded view of a preferred embodiment of the present invention are shown. In the drawings, an array-type tactile feedback touch panel of the present invention includes a touch unit 1, a vibration unit 2, a CPU 3, and a display unit 4.

The touch unit 1 includes a touch panel 12, and the touch panel 12 is one selected from a group consisting of a resistive touch panel, a capacitive touch panel, an infrared touch panel, an optical touch panel, and an ultrasonic touch panel. The touch unit 1 is further provided with a touch driver unit 11, and the touch driver unit 11 is electrically connected to the touch panel 12 and used to compute or record a motion track generated when a preset touch body performs a touch motion on the touch panel 12.

The vibration unit 2 includes a plurality of thin vibrators 21 and a vibration driver unit 22 for driving the vibrators 21. The vibrators 21 are implemented as piezoelectric actuators in the drawings of this embodiment, and each vibrator 21 has two piezoelectric blades overlapping each other. The upper piezoelectric blades are electrically connected to one another, and the lower piezoelectric blades are also electrically connected to one another. The electrical connection manner of the upper piezoelectric blades and the lower piezoelectric blades may be common connection manners adopted by electronic circuit elements such as series connection, parallel connection, series-parallel connection, and parallel-series connection. Finally, the vibration driver unit 22 is electrically connected to the upper piezoelectric blades and the lower piezoelectric blades respectively. In this embodiment, the vibration driver unit 22 is connected to the upper piezoelectric blades with a positive pole, and is connected to the lower piezoelectric blades with a negative pole, but the present invention is not limited hereby in practical implementations, and the positive pole and the negative pole are only intended to illustrate that the vibration driver unit 22 is connected to the upper and lower piezoelectric blades with different connection ends.

When an electric field is applied to the piezoelectric blades, for example, the vibration driver unit 22 generates sinusoidal signals or electrical signals with oscillation, an electric dipole moment is elongated, and the piezoelectric blades extend along the direction of the electric field, that is, the electrical energy is converted into the mechanical energy, thereby generating vibrations. Alternatively, any one of piezoelectric motors, ultrasonic motors, electrets, or other relevant thin vibrators may also be adopted. Furthermore, the vibrators 21 may be disposed on a bottom surface of the display unit 4, disposed between the display unit 4 and the touch unit 1, or disposed on a top surface of the touch unit 1, and the vibrators 21 are disposed in the above units in a manner of being arranged in a matrix or in an array. In addition, the vibrators 21 have the same size or have different sizes, and are in a geometric shape selected from a group consisting of circle, parallelogram, rhombus, rectangle, square, hexagon, and polygon.

The display unit 4 is used to display a preset touch frame, and may be one selected from a cathode ray tube (CRT), a liquid crystal display (LCD), an organic light emitting diode (OLED) panel, a vacuum fluorescent display (VFD) panel, a plasma display panel (PDP), a surface conduction electron-emitter (SED) panel, a field emission display (FED) panel, and an E-Paper, which all fall within the scope of the display unit 4, but are not intended to limit the display unit 4. Specifically, when the display unit 4 is an LCD, the display unit 4 is one selected from a group consisting of a twisted nematic (TN) LCD panel, a vertical alignment (VA) LCD panel, a multi domain vertical alignment (MVA) LCD panel, a patterned vertical alignment (PVA) LCD panel, an in plane switching (IPS) LCD panel, a continuous pinwheel alignment (CPA) LCD panel, an optical compensated bend (OCB) LCD panel, and other LCD panels. When the display unit 4 is an OLED panel, the display unit 4 is one selected from a group consisting of an active matrix organic light emitting diode (AMOLED) panel, a passive matrix organic light emitting diode (PMOLED) panel, and other OLED panels.

The CPU 3 is electrically connected to the display unit 4 and the touch unit 1, and receives the motion track. Meanwhile, the CPU 3 is also electrically connected to the vibration driver unit 22 of the vibration unit 2.

Moreover, in the practical implementations, the touch driver unit 11 and the vibration driver unit 22 are in a form of integrated circuits (IC) electrically connected to the CPU 3, or in a form of firmware recorded in the CPU 3, or in a form of software read and computed by the CPU 3, or in a form of electronic circuits constituted by active and passive devices.

When the touch body performs a touch motion on the touch panel 12 of the touch unit 1, the touch driver unit 11 computes or records the motion track of the touch body, and the motion track may be of a one touch mode (for example, a touch pen or a finger performs a touch motion at a single point), a multi touch mode (for example, several fingers perform the touch motion at the same time), a continuous movement of a single point, or respective movements of multiple points.

Then, the CPU 3 receives the motion track, and finds out corresponding vibrators 21 according to the motion track, such that the vibration driver unit 22 drives the corresponding vibrators 21 to generate vibrations. For example, when the motion track is of a one touch mode, the touch driver unit 11 finds out the position of the touch point, generates the motion track (one touch without moving), and transmits the motion track to the CPU 3. The CPU 3 finds out the vibrator 21 corresponding to the position of the touch point, and then, the vibration driver unit 22 drives the vibrator 21 to generate vibrations. At this time, the touch panel 12 realizes a local tactile feedback (touch feedback) at the position of the touch point. That is because the vibrator 21 corresponding to the single touch point vibrates, and the other vibrators 21 do not generate vibrations.

Furthermore, after the touch body touches the touch panel 12 and generates the local tactile feedback, if the touch body continuously moves on the touch panel 12, the touch driver unit 11 generates the motion track continuously, and the CPU 3 finds out the vibrators 21 corresponding to the motion track in sequence, such that the vibration driver unit 2 drives the vibrators 21 to generate vibrations in sequence.

In the above process, when the touch body leaves the original position, no matter whether it moves while touching the touch panel 12 or moves away from the touch panel 12, the vibrators 21 originally in a vibration state stop vibrating. Alternatively, during the movement of the touch body, the vibrators 21 change the vibration forces according to the distance from the touch body. For example, when the touch body moves away from the vibrator 21 in the vibration state, the generated vibration force is gradually reduced, and in contrast, when the touch body approaches the vibrator 21 in the vibration state, the generated vibration force is gradually increased, and thus the vibrators 21 are capable of generating different vibration effects according to the demands of users and manufacturers during actual applications.

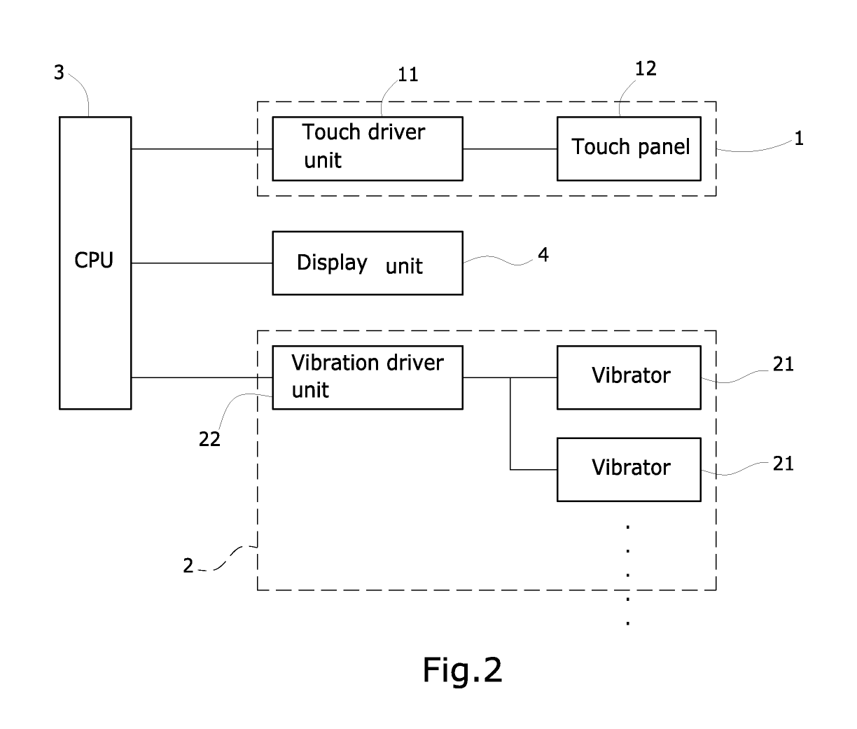

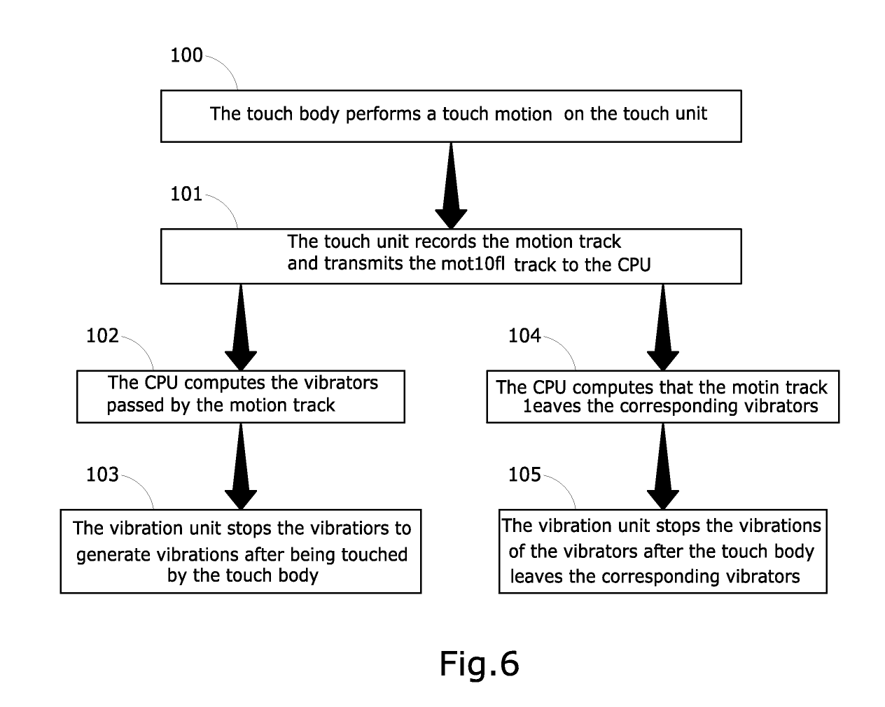

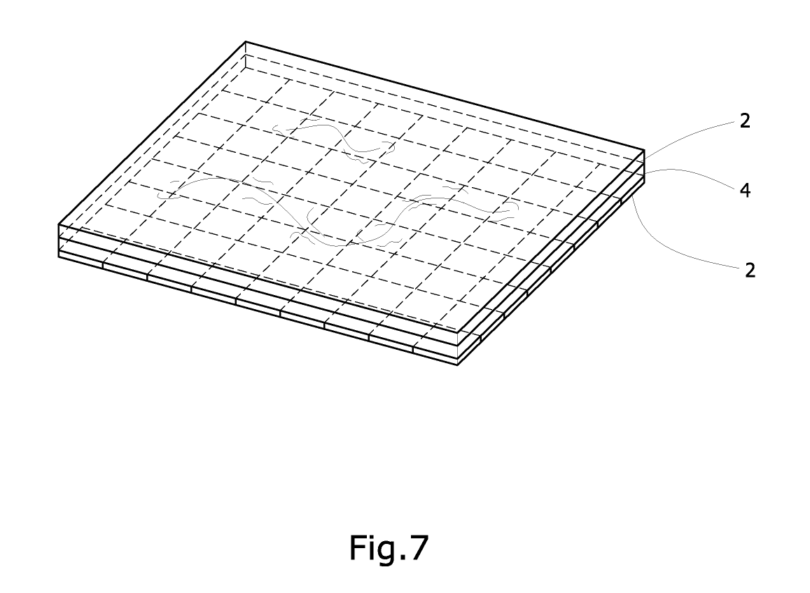

Referring to FIGS. 2, 6, and 7, a second block diagram, a flow chart, and a schematic view of motions of a preferred embodiment of the present invention are shown. In the drawings, the array-type tactile feedback touch panel according to the present invention realizes the tactile feedback according to the following steps.

In Step 100, the touch body performs a touch motion on the touch unit.

In Step 101, the touch unit records the motion track, and transmits the motion track to the CPU.

In the above steps, the touch body performs the touch motion on the touch panel 12 of the touch unit 1, and the touch driver unit 11 computes or records the motion track of the touch body. When the touch body performs a one (multi) touch, the touch driver unit 11 generates the motion track of the one (multi) touch mode, or when the touch body performs the one (multi) touch and moves continuously, the touch driver unit 11 generates the motion track of continuous movement of a single point (multiple points).

In Step 102, the CPU computes the vibrators passed by the motion track.

In Step 103, the vibration unit drives the vibrators to generate vibrations after being tuched by the touch body.

In the above steps, the CPU 3 receives the motion track, finds out the corresponding vibrators 21 according to the motion track, and then, the vibration driver unit 22 drives the vibrators 21 to generate vibrations.

In addition, the Step 101 in which the touch unit records the motion track and transmits the motion track to the CPU further includes the following steps.

In Step 104, the CPU computes that the motion track leaves the corresponding vibrators.

In Step 105, the vibration unit stops the vibrations of the vibrators after the touch body leaves the corresponding vibrators.

In the above steps, the touch body leaves the original position, no matter whether it moves while touching the touch panel 12 or moves away from the touch panel 12, the touch driver unit 11 transmits a motion track about the position change to the CPU 3, and then, the CPU 3 instructs the vibration driver unit 22 to operate, such that the vibrators 21 in the vibration state stop vibrating.

In view of the above steps, it is clear that after the vibrators 21 are disposed in the device in a manner of being arranged in an array or in a matrix, through the operations of the touch driver unit 11, the CPU 3, and the vibration driver unit 22, only the vibrator 21 at the position of the touch point (or referred to as the position on the touch panel 12 touched by the touch body) generates vibrations when the touch body performs the touch motion, whereas the vibrators 21 at the other positions do not generate any motion.

Furthermore, the process that the vibrators 21 generate vibrations after being touched by the touch body is illustrated above. However, in order to improve the variability of the touch vibration, the present invention may have the following vibration effects during the practical application.

Track vibration: when the touch body touches the touch panel 12, the vibrator 21 at the first touch position generates vibrations. Meanwhile, the touch body starts moving on the touch panel 12, that is, the touch body continuously touches the touch panel 12 and moves continuously on the surface of the touch panel 12, and at this time, all the vibrators 21 corresponding to the displacement path of the touch body generate vibrations, for example, when the displacement path of the touch body is L-shaped, the vibrators 21 corresponding to the L-shaped path generate vibrations.

Variable vibration: when the touch body touches the touch panel 12, the corresponding vibrator 21 starts to generate vibrations. Meanwhile, the touch driver unit 11 of the touch panel 12 senses the time and pressure of the touch motion, thus generating corresponding vibration changes. For example, as the pressure of the touch motion becomes increasingly large, the frequency or strength of the vibration may be gradually increased, so as to inform the user that the touch force is too large, thus avoiding the damage caused by excessively large pressure. Alternatively, as the time of the touch motion is increasingly prolonged, the frequency or strength of the vibration may be gradually increased or reduced. Alternatively, the frequency or strength of the vibration is increased or reduced according to the changes of a touch signal value of the touch body, for example, the magnitude of signals about the capacitance (current value) detected, computed, or stored by the touch sensing element, and thus, diversified tactile feedback effects may be achieved corresponding to different application programs or touch programs.

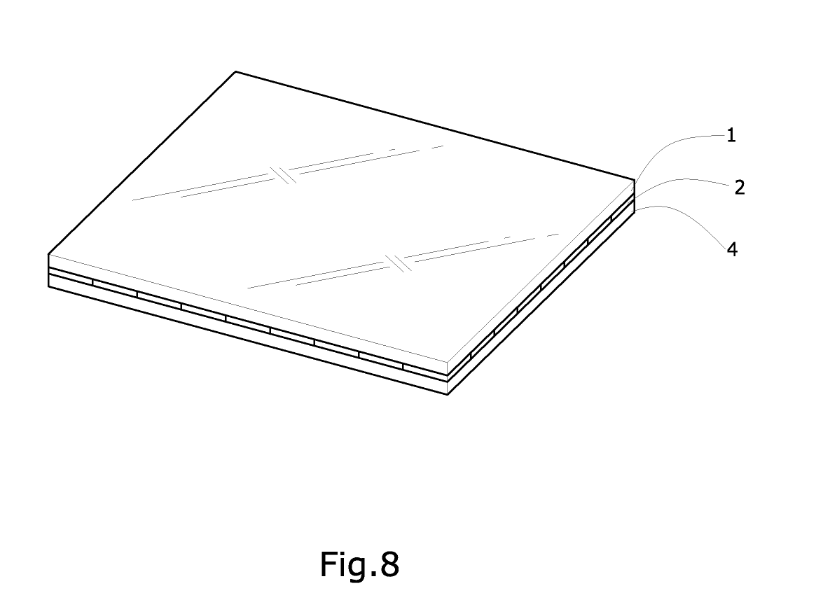

Referring to FIGS. 2 and 8, a second block diagram of a preferred embodiment of the present invention and a three-dimensional view of another preferred embodiment of the present invention are shown. In the drawings, in order to make the vibration of the touch feedback more obvious, the vibrators 21 of the vibration unit 2 are disposed between the touch unit 1 and the display unit 4. If it is defined that the frame displayed by the display unit 4 can be directly viewed by naked eyes, the stacking sequence is that, the vibrators 21 are disposed under the touch panel 12 and the display unit 4 is disposed under the vibrators 21.

Therefore, in order to enable the frame displayed by the display unit 4 to transmit through the vibrators 21, the vibrators 21 are made of transparent materials, for example, transparent plastic materials combined with conductive materials. Particularly, the conductive material is disposed on a surface of the plastic material (such as a plastic plate or a plastic sheet), or is directly added in the plastic material to form a conductive plastic material. In this embodiment, the plastic material is a plastic polymer selected from a group consisting of flourine polymer, flourine ethylene propylene (FEP), poly tetra fluoro ethylene (PTFE), poly vinylidene fluoride (PVDF), silicone, Si₃N₄, teflon, polyimide photo resist, resin, plastic, poly ethylene terephthalate (PET), polyamide (PA), poly carbonate (PC), poly ethylene (PE), poly vinyl chloride (PVC), poly propylene (PP), poly styrene (PS), poly methyl meth acrylate (PMMA), and a combination thereof.

The conductive materials enabling the plastics to have well conductivity are classified into P-type conductive materials and N-type conductive materials, and the N-type conductive materials may be selected from a group consisting of impurity doped oxides, binary compounds, and ternary compounds.

The impurity doped oxide is one selected from a group consisting of indium tin oxide (ITO), indium zinc oxide (IZO), Al doped ZnO (AZO), and antimony tin oxide (ATO).

The binary compound is one selected from a group consisting of SnO₂+In₂O₃, ZnO+SnO₂, and ZnO+In₂O₃.

The ternary compound is one selected form a group consisting of Cd₂SnO₄, CdSnO₃, CdIn₂O₄, Zn₂In₂O₅+MgIn₂O₄, Zn₂In₂O₅+In₄Sn₃O₁₂, and ZnSnO₃+In₄Sn₃O₁₂.

In addition, the P-type conductive materials are selected from a group consisting of oxides having lattice structures (AMO₂) compounded by monovalent and trivalent metal ions. The monovalent metal ion is one selected from a group consisting of Li, Cu, and Ag, and the trivalent metal ion is one selected from a group consisting of Al, Ga, and In.

In addition to the above common types of P-type (N-type) conductive materials, the conductive material may also be conjugated conductive plastics, which is selected from a group consisting of 3,4-ethylenedioxythiophene (PEDOT), poly aniline (PANI), and polypyrrole (PPy). In addition, the poly acetylene is selected from a group of aliphatic linear conjugated conductive plastics, the PANI is selected from a group of aromatic linear conjugated conductive plastics, and the PPy is selected from a group of aromatic heterocyclic linear conjugated conductive plastics. The conjugated conductive plastics belong to electron conductive polymers, which are characterized in large π-electron conjugation system existing in the molecular structure of the polymer. The π electrons have strong delocalization property, and are capable of migrating relatively in the system. Thus, when an external electric field exists, the π electrons in the material may generate a current flowing in a fixed direction, thus presenting an electron conductive phenomenon.

The electrical conductivity is closely related to the magnitude of the conjugation system, doping state, types of dopants, and doping extent. Different from the metal conductors, the conjugation conductive plastics have a positive temperature coefficient, and the higher the temperature is, the stronger the conductive capability will be.

In addition to the above P-type or N-type conductive materials, the conductive material may also be carbon nanotube, and the carbon nanotube is generally classified into single walled carbon nanotubes (SWNTs) and multi walled carbon nanotubes (MWNTs). The single walled carbon nanotubes may be further classified into armchair nanotube, zigzag nanotube, and chiral nanotube according to different structure configurations thereof. In the present invention, the implementation of a carbon nanotube transparent conductive film includes: coating the carbon nanotube dispersion uniformly on a surface of a plastic substrate, and then filing an adhesive component in gaps of the carbon nanotube dispersion net; or spraying or dipping the carbon nanotube on a surface of the substrate by using an adhesion layer.

Therefore, the conductive materials in the present invention are not limited to the types of conductive materials described above, and other materials capable of enabling the plastic materials to have conductivity all fall within the scope of the present invention.

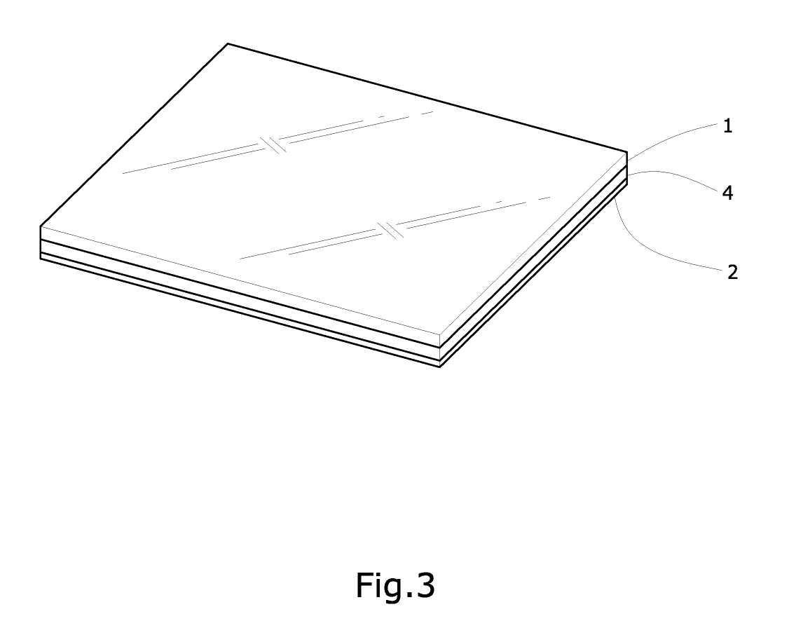

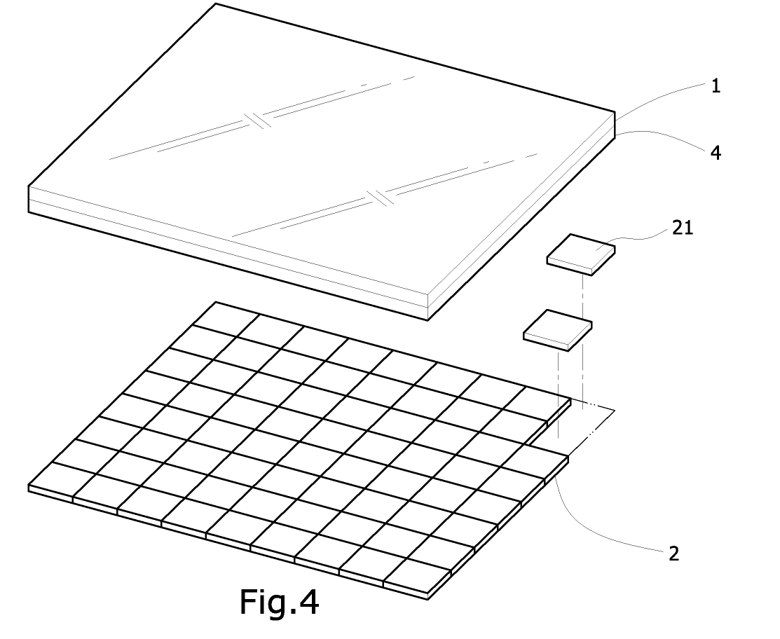

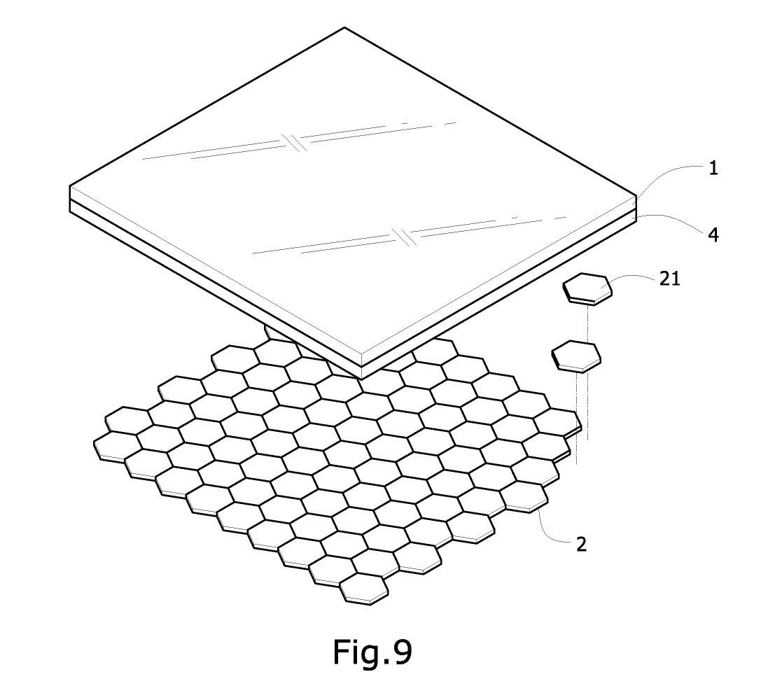

Referring to FIG. 9, a three-dimensional view of still another preferred embodiment of the present invention is shown. In the drawing, this embodiment is different from that of FIGS. 3 and 4 in that, the vibrators 21 may also be configured in a shape of hexagon or polygon, in addition to the rectangular shape described in the above embodiments. Different vibration areas are generated by configuring the vibrators 21 in different shapes, for example, when the touch area displayed by the touch panel 12 is in a shape of polygon, by using the polygon-shaped vibrators 21, the touch area can be fully covered by the vibrators 21, such that the vibration generated during the touch motion does not exceed the range of the touch area.

By using the vibrators 21 of other shapes, the present invention may be integrated to electronic products with different shapes, such as a round display, a polygon-shaped display, and an arc-shaped display of a game table. For a more practical example, the vibration area is further extended to every corner of the touch panel, thus effectively enlarging the vibration area.

What is claimed is:

1. An array-type tactile feedback touch panel, comprising:
a touch unit, for recording a motion track change of a preset touch body during a touch motion;
a central processing unit (CPU), electrically connected to the touch unit, for receiving the motion track;
a vibration unit, having a plurality of thin vibrators, for driving the vibrators on the motion track to generate vibrations; and
a display unit, for displaying a preset touch frame.

2. The array-type tactile feedback touch panel according to claim 1, wherein the touch unit comprises: a touch panel, provided for the touch body to perform a touch motion, and a touch driver unit, used to compute the motion track of the touch body.

3. The array-type tactile feedback touch panel according to claim 2, wherein the touch driver unit computes a motion track of a one touch mode or a motion track of a multi touch mode.

4. The array-type tactile feedback touch panel according to claim 2, wherein the touch panel is one selected from a resistive touch panel, a capacitive touch panel, an infrared touch panel, an optical touch panel, and an ultrasonic touch panel.

5. The array-type tactile feedback touch panel according to claim 2, wherein the touch driver unit is in a form of an integrated circuit (IC) electrically connected to the CPU, or in a form of firmware recorded in the CPU, or in a form of software read and computed by the CPU, or in a form of an electronic circuit constituted by active and passive devices.

6. The array-type tactile feedback touch panel according to claim 1, wherein the display unit is one selected from a group consisting of a cathode ray tube (CRT), a liquid crystal display (LCD), an organic light emitting diode (OLED) panel, a vacuum fluorescent display (VFD) panel, a plasma display panel (PDP), a surface conduction electron-emitter (SED) panel, a field emission display (FED) panel, and an E-Paper.

7. The array-type tactile feedback touch panel according to claim 6, wherein the liquid crystal display (LCD) is one selected from a group consisting of a twisted nematic (TN) LCD panel, a vertical alignment (VA) LCD panel, a multi domain vertical alignment (MVA) LCD panel, a patterned vertical alignment (PVA) LCD panel, an in plane switching (IPS) LCD panel, a continuous pinwheel alignment (CPA) LCD panel, an optical compensated bend (OCB) LCD panel.

8. The array-type tactile feedback touch panel according to claim 6, wherein the organic light emitting diode (OLED) panel is one selected from a group consisting of an active matrix organic light emitting diode (AMOLED) panel, a passive matrix organic light emitting diode (PMOLED) panel.

9. The array-type tactile feedback touch panel according to claim 1, wherein the vibrators of the vibration unit are disposed on a bottom surface of the display unit, and the touch unit is disposed on a top surface of the display unit.

10. The array-type tactile feedback touch panel according to claim 1, wherein the vibrators of the vibration unit are disposed between the display unit and the touch unit.

11. The array-type tactile feedback touch panel according to claim 1, wherein the vibrators of the vibration unit are disposed on a top surface of the touch unit, and the touch unit is disposed on a top surface of the display unit.

12. The array-type tactile feedback touch panel according to claim 1, wherein the vibrators of the vibration unit are made of a transparent plastic material combined with a conductive material.

13. The array-type tactile feedback touch panel according to claim 12, wherein the conductive material is one selected from a group of N-type conductive plastic thin films consisting of impurity doped oxides, binary compounds, and ternary compounds.

14. The array-type tactile feedback touch panel according to claim 13, wherein the conductive material is one selected from a group of impurity doped oxides consisting of indium tin oxide (ITO), indium zinc oxide (IZO), Al doped ZnO (AZO), and antimony tin oxide (ATO).

15. The array-type tactile feedback touch panel according to claim 13, wherein the conductive material is one selected from a group of binary compounds consisting of SnO₂+In₂O₃, ZnO+SnO₂, and ZnO+In₂O₃.

16. The array-type tactile feedback touch panel according to claim 13, wherein the conductive material is one selected from a group of ternary compounds consisting of Cd₂SnO₄, CdSnO₃, CdIn₂O₄, Zn₂In₂O₅+MgIn₂O₄, Zn₂In₂O₅+In₄Sn₃O₁₂, and ZnSnO₃+In₄Sn₃O₁₂.

17. The array-type tactile feedback touch panel according to claim 12, wherein the conductive material is one selected from a group of P-type conductive plastic thin films consisting of oxides with lattice structures (AMO₂) compounded by monovalent and trivalent metal ions.

18. The array-type tactile feedback touch panel according to claim 17, wherein the monovalent metal ion is one selected from a group consisting of Li, Cu, and Ag.

19. The array-type tactile feedback touch panel according to claim 17, wherein the trivalent metal ion is one selected from a group consisting of Al, Ga, and In.

20. The array-type tactile feedback touch panel according to claim 12, wherein the conductive material is one selected from a group of conjugated conductive plastics consisting of 3,4-ethylenedioxythiophene (PEDOT), poly aniline (PANI), and polypyrrole (PPy).

21. The array-type tactile feedback touch panel according to claim 20, wherein the conductive material is selected from a group of aliphatic linear conjugated conductive plastics consisting of poly acetylene.

22. The array-type tactile feedback touch panel according to claim 20, wherein the conductive material is selected from a group of aromatic linear conjugated conductive plastics consisting of PANI.

23. The array-type tactile feedback touch panel according to claim 20, wherein the conductive material is selected from a group of aromatic heterocyclic linear conjugated conductive plastics consisting of PPy.

24. The array-type tactile feedback touch panel according to claim 12, wherein the conductive material is carbon nanotube.

25. The array-type tactile feedback touch panel according to claim 24, wherein the carbon nanotube is one selected from single walled carbon nanotubes (SWNTs) or multi walled carbon nanotubes (MWNTs).

26. The array-type tactile feedback touch panel according to claim 12, wherein the plastic material is a plastic polymer selected from a group consisting of flourine polymer, flourine ethylene propylene (FEP), poly tetra fluoro ethylene (PTFE), poly vinyli dene fluoride (PVDF), silicone, Si₃N₄, teflon, polyimide photo resist, resin, plastic, poly ethylene terephthalate (PET), polyamide (PA), poly carbonate (PC), poly ethylene (PE), poly vinyl chloride (PVC), poly propylene (PP), poly styrene (PS), poly methyl meth acrylate (PMMA), and a combination thereof.

27. The array-type tactile feedback touch panel according to claim 1, wherein the vibrators of the vibration unit are selected from a group consisting of piezoelectric actuators, piezoelectric motors, ultrasonic motors, electrets, and relevant thin vibrators.

28. The array-type tactile feedback touch panel according to claim 1, wherein the vibrators of the vibration unit are arranged in a matrix or in an array.

29. The array-type tactile feedback touch panel according to claim 1, wherein the vibrators of the vibration unit are in a geometric shape selected from a group consisting of orthogon, circle, parallelogram, rhombus, rectangle, square, hexagon, and polygon.

30. The array-type tactile feedback touch panel according to claim 1, wherein the vibrators of the vibration unit have the same or different sizes.

31. The array-type tactile feedback touch panel according to claim 1, wherein the vibration unit is further provided with a vibration driver unit used to drive the vibrators.

32. The array-type tactile feedback touch panel according to claim 31, wherein the vibration driver unit is in a form of an integrated circuit (IC) electrically connected to the CPU, or in a form of firmware recorded in the CPU, or in a form of software read and computed by the CPU, or in a form of an electronic circuit constituted by active and passive devices.

33. The array-type tactile feedback touch panel according to claim 1, wherein the touch panel performs a tactile feedback according to the following steps:
performing a touch motion on the touch unit by the touch body;
recording the motion track and transmitting the motion track to the CPU by the touch unit;
computing, by the CPU, the vibrators passed by the motion track; and
driving, by the vibration unit, the vibrators to generate vibrations after being touched by the touch body.

34. The array-type tactile feedback touch panel according to claim 33, wherein the step of computing, by the CPU, the vibrators passed by the motion track further comprises:
computing that the motion track leaves corresponding vibrators by the CPU; and
stopping the vibrations of the corresponding vibrators by the vibration unit after the touch body leaves the vibrators.
